(19) United States
(12) Patent Application Publication
(10) Pub. No.: US 2017/0092271 A1
(43) Pub. Date: Mar. 30, 2017

(54) SEMICONDUCTOR DEVICE, SYSTEM, ELECTRONIC DEVICE, AND SPEECH RECOGNITION METHOD

(71) Applicant: SEIKO EPSON CORPORATION, Tokyo (JP)

(72) Inventor: Fumihito BAISHO, Kai-shi (JP)

(73) Assignee: SEIKO EPSON CORPORATION, Tokyo (JP)

(21) Appl. No.: 15/266,282

(22) Filed: Sep. 15, 2016

(30) Foreign Application Priority Data
Sep. 24, 2015 (JP) 2015-186472

(51) Int. Cl. G10L 15/22; G10L 15/28; G10L 13/02

(52) U.S. Cl. CPC G10L 15/22; G10L 13/02; G10L 15/28

(57) ABSTRACT

A semiconductor device is provided with a data storage unit configured to store speech reproduction data that includes transition destination information or speech recognition option data that includes transition destination information, and a processor configured to perform processing for generating an output speech signal using speech reproduction data read out from the data storage unit or perform speech recognition processing on an input speech signal using speech recognition option data read out from the data storage unit, and to read out, based on the transition destination information included in speech reproduction data or speech recognition option data used in the processing, speech recognition option data or speech reproduction data to be used in the next processing from the data storage unit.

### BACKGROUND

1. Technical Field

The present invention relates to a semiconductor device having a speech recognition function, a system using such a semiconductor device, and an electronic device using such a system. Furthermore, the invention relates to a speech recognition method that is used in such a semiconductor device, system or electronic device, and the like.

2. Related Art

Speech recognition is a technology that obtains a speech recognition result, by analyzing speech signals that are input and collating feature patterns that are obtained as a result of the analysis with standard patterns (called “templates”) that are provided in a speech recognition database based on prerecorded speech signals. In order to improve the recognition rate together with reducing the processing time of speech recognition, restriction of the number of standard patterns to be compared is also carried out, by performing speech recognition in line with a preset scenario.

Generally, in order to realize scenario control in speech recognition, it is necessary to incorporate a program that fully controls a scenario flow in a host CPU that controls speech recognition processing and speech reproduction processing, or to incorporate a program that designates scenario flow information in a speech recognition device that performs speech recognition processing and speech reproduction processing in accordance with the scenario flow information.

As related technology, JP-A-2015-14665 (paras. 0007-0008; FIG. 1) discloses a semiconductor integrated circuit device that is able to easily realize setting and changing of scenarios in speech recognition. This semiconductor integrated circuit device is provided with a scenario setting unit that receives a command designating scenario flow information that represents a relationship between a plurality of speech reproduction data and a plurality of conversion lists, and that selects applicable speech reproduction data from a plurality of speech reproduction data that are stored in a speech reproduction data storage unit and selects an applicable conversion list from a plurality of conversion lists stored in a conversion list storage unit, in accordance with the scenario flow information.

However, in the case where a program controls the scenario flow or designates scenario flow information, the program must be modified if the scenario is changed, and tasks such as changing and evaluating the program require much time and effort.

### SUMMARY

An advantage of some aspects of the invention is to provide a semiconductor device that is able to easily realize setting and changing of a scenario in speech recognition, even without setting or changing the scenario flow in a program. Another advantage of some aspects of the invention is to provide a system that uses such a semiconductor device, and an electronic device that uses such a system. A further advantage of some aspects of the invention is to provide a speech recognition method that is used in such a semiconductor device, system or electronic device, and the like.

In order to solve at least some of the above problems, a semiconductor device according to a first aspect of the invention includes a data storage unit configured to store speech reproduction data that includes transition destination information or speech recognition option data that includes transition destination information, and a processor configured to perform processing for generating an output speech signal using speech reproduction data read out from the data storage unit or perform speech recognition processing on an input speech signal using speech recognition option data read out from the data storage unit, and to read out, based on the transition destination information included in speech reproduction data or speech recognition option data used in the processing, speech recognition option data or speech reproduction data to be used in the next processing from the data storage unit.

Also, a speech recognition method according to a second aspect of the invention includes (a) reading out first speech reproduction data or first speech recognition option data from a data storage unit configured to store speech reproduction data that includes transition destination information or speech recognition option data that includes transition destination information, (b) performing processing for generating an output speech signal using the first speech reproduction data or performing speech recognition processing on an input speech signal using the first speech recognition option data, (c) reading out, based on the transition destination information included in first speech reproduction data or first speech recognition option data used in the processing in (b), second speech recognition option data or second speech reproduction data to be used in the next processing from the data storage unit, and (d) performing speech recognition processing on an input speech signal using the second speech recognition option data or generating an output speech signal using the second speech reproduction data.

According to the first or second aspect of the invention, transition destination information is embedded in speech reproduction data or speech recognition option data, and thus in the case where a scenario in speech recognition needs to be changed, it is possible to change the scenario by only changing the speech reproduction data or the speech recognition option data. Accordingly, setting and changing of a scenario in speech recognition can be easily realized, even without setting or changing the scenario flow in a program.

In the semiconductor device according to the first aspect of the invention, a configuration may be adopted in which the data storage unit is configured to further store image reproduction data that includes transition destination information, and the processor is configured to perform processing for generating an output speech signal using speech reproduction data read out from the data storage unit, processing for displaying an image that includes a question or message using image reproduction data read out from the data storage unit or speech recognition processing on an input speech signal using speech recognition option data read out from the data storage unit, and to read out, based on the transition destination information included in speech reproduction data, image reproduction data or speech recognition option data used in the processing, speech recognition option data, speech reproduction data or image reproduction data to be used in the next processing from the data storage unit. By displaying an image that includes a question or message on a display unit, the contents of the question or message can be more accurately conveyed to a user.

Also, a configuration may be adopted in which the processor includes a scenario controller configured to transmit, to outside, the transition destination information included in speech reproduction data, image reproduction data or speech recognition option data used in the processing, and to receive, from outside, speech recognition option data, speech reproduction data or image reproduction data to be used in the next processing. In that case, the timing of the respective processing in the scenario flow can be controlled externally.

Furthermore, a configuration may be adopted in which the transition destination information includes an ending flag representing the end of a series of processing. In that case, the end of a series of processing in the scenario flow can be notified externally, by transmitting transition destination information including an ending flag or a scenario end signal representing the end of the scenario externally.

A system according to a third aspect of the invention is provided with any of the above semiconductor devices and a controller that controls the semiconductor device. Thereby, it becomes possible to provide a system that is able to easily realize setting and changing of a scenario in speech recognition even without setting or changing the scenario flow in a program.

Here, a configuration may be adopted in which the controller includes a storage unit configured to store speech reproduction data that includes transition destination information, image reproduction data that includes transition destination information, or speech recognition option data that includes transition destination information, and a host CPU configured to, when transition destination information is received from the semiconductor device, read out speech recognition option data, speech reproduction data or image reproduction data to be used in the next processing from the storage unit, based on the received transition destination information, and transmit the read data to the semiconductor device. In that case, the timing of respective processing in the scenario flow can be controlled by the host CPU.

An electronic device according to a fourth aspect of the invention is provided with the above system. Thereby, it becomes possible to provide an electronic device that is able to easily realize setting and changing of a scenario in speech recognition even without setting or changing the scenario flow in a program.

### BRIEF DESCRIPTION OF THE DRAWINGS

The invention will be described with reference to the accompanying drawings, wherein like numbers reference like elements.

FIG. 1 is a diagram showing an exemplary configuration of a system using a semiconductor device according to a first embodiment.

FIG. 2 is a flowchart showing a speech recognition method according to the first embodiment.

FIG. 3 is a diagram showing an exemplary configuration of a system using a semiconductor device according to a second embodiment.

FIG. 4 is a flowchart showing a speech recognition method according to the second embodiment.

FIG. 5 is a diagram showing exemplary speech reproduction data that is stored in a storage unit.

FIG. 6 is a diagram showing exemplary speech recognition option data that is stored in a storage unit.

FIG. 7 is a diagram showing exemplary speech recognition scenarios.

FIG. 8 is a block diagram showing an exemplary configuration of an electronic device according to one embodiment of the invention.

### DESCRIPTION OF EXEMPLARY EMBODIMENTS

Hereinafter, embodiments of the invention will be described in detail, with reference to the drawings. Note that like reference signs are given to like constituent elements, and redundant description will be omitted.

### First Embodiment

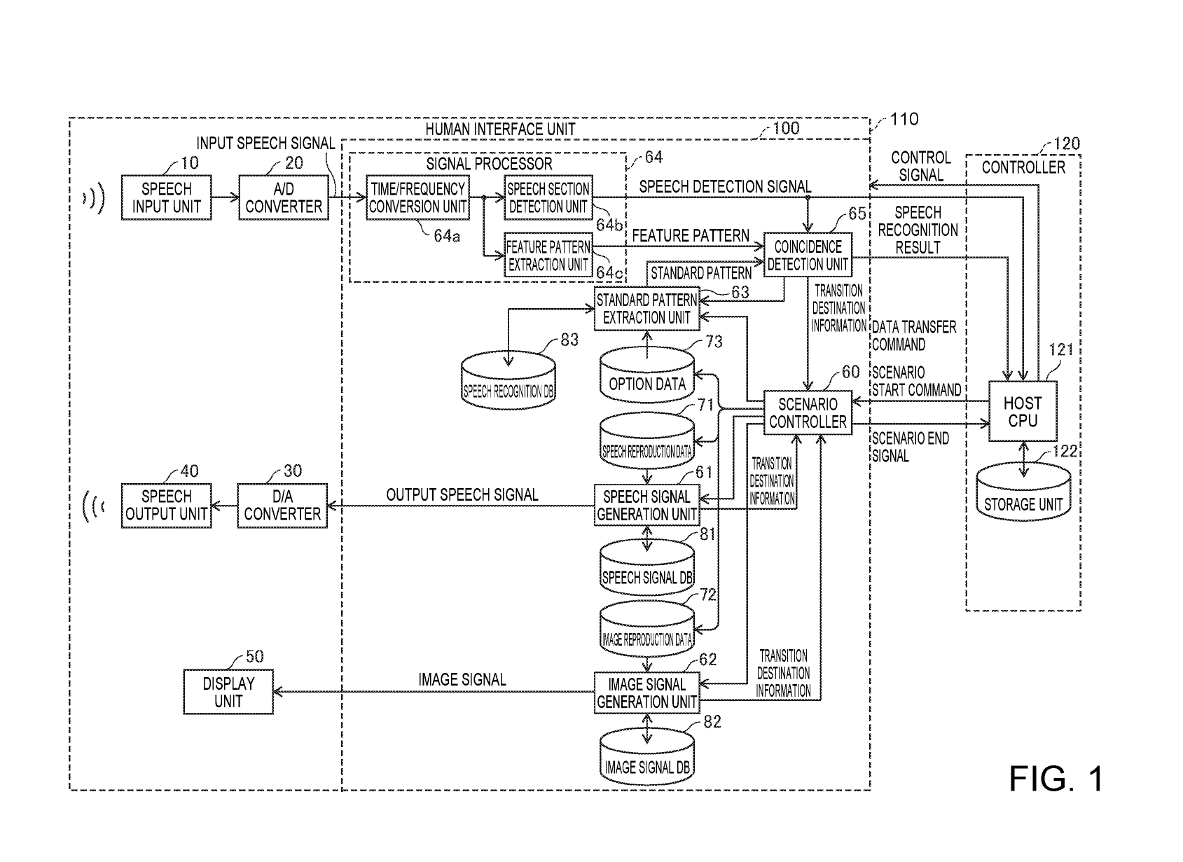

FIG. 1 is a block diagram showing an exemplary configuration of a system using a semiconductor device according to a first embodiment of the invention. As shown in FIG. 1, this system is constituted by a human interface unit 110 and a controller 120.

The human interface unit 110 issues speech of a question or message to a user, and also recognizes speech of a user who replies to the question or message and performs a response or processing corresponding to a speech recognition result. In the following, the case where the human interface unit 110 displays an image including a question or message together with speech or instead of speech will be described, but in the case where the human interface unit 110 does not perform image display, configuration and data relating to image display will not be required.

The human interface unit 110 includes a speech input unit 10, an A/D converter 20, a D/A converter 30, a speech output unit 40, a display unit 50, and a semiconductor device 100. Note that at least some of the speech input unit 10, the A/D converter 20, the D/A converter 30 and the speech output unit 40 may be incorporated in the semiconductor device 100.

The semiconductor device 100 includes a scenario controller 60, a speech signal generation unit 61, an image signal generation unit 62, a standard pattern extraction unit 63, a signal processor 64, and a coincidence detection unit 65. Also, the semiconductor device 100 includes a speech reproduction data storage unit 71, an image reproduction data storage unit 72, an option data storage unit 73, a speech signal database (DB) storage unit 81, an image signal database (DB) storage unit 82, and a speech recognition database (DB) storage unit 83.

The controller 120 includes a host CPU (central processing unit) 121 and a storage unit 122. The host CPU 121 operates based on software (speech recognition control program) that is recorded on a recording medium of the storage unit 122. A hard disk, a flexible disk, an MO, an MT, various types of memories, a CD-ROM, a DVD-ROM or the like can be used as the recording medium.

The storage unit 122 stores speech reproduction data, image reproduction data and speech recognition option data that are used in the human interface unit 110. Speech reproduction data includes data (e.g., text data, etc.) that is used in order to generate an output speech signal representing the speech waveform of a question or message that is issued to the user from the speech output unit 40. The attention of the user can be drawn by issuing the speech of a question or message.

Image reproduction data includes data (e.g., text data, etc.) that is used in order to generate an image signal representing an image including a question or message to be displayed on the display unit 50. By displaying an image including a question or message on the display unit 50, the contents of the question or message can be more accurately conveyed to the user.

Speech recognition option data includes data (e.g., text data, etc.) representing words or sentences constituting a plurality of options in speech recognition processing for recognizing the speech of the user who replies to a question or message conveyed through speech or an image. By issuing a question or message through speech or an image to the user, a situation arises in which the reply by the user to the question or message is predicted to be one of a number of words or sentences.

At least one of speech reproduction data, image reproduction data and speech recognition option data includes transition destination information that specifies data to be used in the next processing after the processing that is performed using the speech reproduction data, image reproduction data or speech recognition option data. Herein, information specifying speech reproduction data, image reproduction data or speech recognition option data is also called a “data name”. In the following, the case where speech reproduction data, image reproduction data and speech recognition option data each include transition destination information will be described as an example. Note that the speech recognition option data represents a plurality of options, and thus includes transition destination information corresponding to each of the plurality of options.

The host CPU 121 controls various types of operations of the human interface unit 110, by outputting control signals to the human interface unit 110. Also, the host CPU 121 transmits speech reproduction data, image reproduction data and speech recognition option data that are stored in the storage unit 122 to the scenario controller 60 by attachment to a data transfer command. Transfer of data may be performed collectively with regard to the series of processing in the scenario flow, or may be performed sequentially with regard to the respective processing in the scenario flow, as will be described in the second embodiment.

When starting a human interface operation, the host CPU 121 may control the human interface unit 110 so as to perform processing in line with a preset scenario, by transmitting a scenario start command to the scenario controller 60. In that case, the scenario start command may also include information designating data to be used in processing that is initially executed in the scenario flow.

The speech input unit 10 includes, for example, a microphone that converts speech into an electrical signal (speech signal), an amplifier that amplifies the speech signal that is output from the microphone, and a low pass filter that restricts the band of the amplified speech signal. The A/D converter 20 converts an analog speech signal that is output from the speech input unit 10 into a digital speech signal (speech data) by sampling the analog speech signal. For example, the speech frequency band of speech data is 12 kHz, and the bit count is 16 bits.

In the semiconductor device 100, the scenario controller 60, the speech signal generation unit 61, the image signal generation unit 62, the standard pattern extraction unit 63, the signal processor 64 and the coincidence detection unit 65 are equivalent to a processor that performs processing for generating an output speech signal, processing for displaying an image on the display unit 50, or speech recognition processing, and are, for example, constituted by a logic circuit that includes a combinational circuit and a sequential circuit, or the like.

Also, the speech reproduction data storage unit 71 to the option data storage unit 73 are equivalent to a data storage unit that stores speech reproduction data, image reproduction data and speech recognition option data that are used in the processor, and are, for example, constituted by a memory or a resistor. Also, the speech signal database storage unit 81 to the speech recognition database storage unit 83 may, for example, be constituted by a memory such as a nonvolatile memory, and at least some of these units may be incorporated in a memory that is externally attached to the semiconductor device 100.

The scenario controller 60 receives speech reproduction data, image reproduction data and speech recognition option data from the host CPU 121 of the controller 120, and stores the speech reproduction data in the speech reproduction data storage unit 71, the image reproduction data in the image reproduction data storage unit 72 and the speech recognition option data in the option data storage unit 73 after identifying the type of data.

The scenario controller 60, upon receiving a scenario start command from the host CPU 121, outputs a data name that is represented by information designating data to be used in processing that is initially performed in a scenario flow to the speech signal generation unit 61, the image signal generation unit 62 or the standard pattern extraction unit 63, in accordance with the type of data.

In the case where the data name is output to the speech signal generation unit 61, the speech signal generation unit 61 performs processing for reading out speech reproduction data that is specified by the data name from the speech reproduction data storage unit 71, and generating an output speech signal representing speech of a question or message for the user, using the read speech reproduction data. In the case where the speech reproduction data is text data, a speech signal database that is stored in the speech signal database storage unit 81 is used, in order to generate an output speech signal.

For example, speech signals representing speech waveforms corresponding to various types of phonemes are accumulated in the speech signal database. The speech signal generation unit 61 synthesizes output speech signals, by connecting speech signals with regard to a plurality of phonemes that are included in words or sentences that are represented by text data. Alternatively, a plurality of output speech signals representing speech waveforms that correspond to various types of text data may be accumulated in the speech signal database. In that case, the speech signal generation unit 61 selects the output speech signal corresponding to the read text data.

The D/A converter 30 converts a digital speech signal that is output from the speech signal generation unit 61 into an analog speech signal. The speech output unit 40 includes, for example, a power amplifier that power amplifies the analog speech signal that is output from the D/A converter 30, and a speaker that issues speech according to the power amplified speech signal. The speaker outputs speech of a question or message that is represented by the speech signal. Thereby, the speech of a question or message for the user is issued from the speech output unit 40.

In the case where the data name is output to the image signal generation unit 62, the image signal generation unit 62 performs processing for reading out image reproduction data that is specified by the data name from the image reproduction data storage unit 72, and displaying an image that includes a question or message for the user on the display unit 50, using the read image reproduction data. In the case where the image reproduction data is text data, an image signal database that is stored in the image signal database storage unit 82 is used, in order to generate an image signal.

For example, image signals representing various types of characters are accumulated in the image signal database. The image signal generation unit 62 synthesizes image signals, by connecting image signals with regard to a plurality of characters that are included in text data. Alternatively, a plurality of image signals that are specified by various types of image reproduction data may be accumulated in the image signal database. In that case, the image signal generation unit 62 selects an image signal that is specified by the read image reproduction data. The display unit 50 includes a display panel that is constituted by a liquid crystal display or the like, and displays an image including a question or message for the user, in accordance with the image signal that is output from the image signal generation unit 62.

In the case where the data name is output to the standard pattern extraction unit 63, the standard pattern extraction unit 63 reads out speech recognition option data that is specified by the data name from the option data storage unit 73. The standard pattern extraction unit 63 to the coincidence detection unit 65 perform speech recognition processing on the input speech signal using the read speech recognition option data. Thus, the standard pattern extraction unit 63 extracts standard patterns corresponding to at least some of the various words or sentences constituting the plurality of options that are represented by the speech recognition option data from a speech recognition database that is stored in the speech recognition database storage unit 83.

The signal processor 64 includes a time/frequency conversion unit 64a, a speech section detection unit 64b, and a feature pattern extraction unit 64c. The time/frequency conversion unit 64a extracts a frequency component of a speech signal that is input from the A/D converter 20 by performing a Fourier transform or the like on the input speech signal. The speech section detection unit 64b activates a speech detection signal based on the sound pressure or S/N ratio of the input speech signal, and outputs the speech detection signal to the coincidence detection unit 65 and the host CPU 121. Thereby, the existence of a request or reply from the user can be determined. The feature pattern extraction unit 64c generates a feature pattern representing the distribution state of the frequency component of the input speech signal, and outputs the feature pattern to the coincidence detection unit 65.

The coincidence detection unit 65 operates when the speech detection signal has been activated, and, by comparing a feature pattern generated from at least a portion of the input speech signal with a standard pattern extracted from the speech recognition database, detects coincidence between the two patterns. The coincidence detection unit 65 outputs information specifying words or sentences having syllables with respect to which coincidence was detected among the words or sentences constituting a plurality of options, such as, for example, text data representing those words or sentences, to the host CPU 121 as a speech recognition result. Thereby, the host CPU 121 is able to recognize words or sentences corresponding to at least a portion of the speech signal input to the semiconductor device 100.

In this embodiment, the speech signal generation unit 61, the image signal generation unit 62, and the standard pattern extraction unit 63 to the coincidence detection unit 65 perform respective processing using speech reproduction data, image reproduction data and speech recognition option data read out from the data storage units, and output transition destination information that is included in the speech reproduction data, image reproduction data and speech recognition option data used in the respective processing to the scenario controller 60.

The scenario controller 60 outputs a data name specifying data to be used in the next processing to the standard pattern extraction unit 63, the speech signal generation unit 61 or the image signal generation unit 62 in accordance with the type of data, based on the transition destination information output from the speech signal generation unit 61, the image signal generation unit 62 or the coincidence detection unit 65. Thereby, the standard pattern extraction unit 63, the speech signal generation unit 61 or the image signal generation unit 62 reads out speech recognition option data, speech reproduction data or image reproduction data to be used in the next processing from the data storage unit, and performs the next processing.

For example, the order of processing in the scenario flow may involve different processing being continuously performed, such as performing speech recognition processing after performing speech reproduction processing, and performing speech reproduction processing after performing speech recognition processing. Alternatively, the same processing may be continuously performed such as performing speech reproduction processing continuously after performing speech reproduction processing. Also, different processing may be performed at the same time, such as performing speech reproduction processing while image reproduction processing is being performed.

In the case where data is not designated in the transition destination information, the series of processing in the scenario flow is ended. Alternatively, a configuration may be adopted in which the transition destination information includes an ending flag (scenario ending flag) representing the end of the series of processing in the scenario flow. In that case, the scenario controller 60 is able to notify the end of the series of processing in the scenario flow externally, by transmitting transition destination information including a scenario ending flag or a scenario end signal representing the end of the scenario to the external host CPU 121 or the like.

### Technique for Deriving Feature Pattern

Next, an example of a technique of deriving a feature pattern from an input speech signal will be described. The time/frequency conversion unit 64a of the signal processor 64 partitions a time-series speech signal every predetermined period of time to create a plurality of frames, by applying a humming window to the speech waveform that is represented by the input speech signal. Also, the time/frequency conversion unit 64a extracts a plurality of frequency components, by Fourier-transforming the speech signal on a frame-by-frame basis.

Furthermore, the time/frequency conversion unit 64a derives numerical values of a number corresponding to the number of windows, by integrating the absolute value of these frequency components in each of the windows of a frequency area determined based on the Mel scale, and logarithmically transforms these numerical values. Thereby, if there are 26 windows in the frequency area, 26 numerical values (Mel-band coefficients) are obtained.

The low order Mel-band coefficients (e.g., 12) among the Mel-band coefficients thus obtained are called MFCCs (Mel-frequency cepstral coefficients). The feature pattern extraction unit 64c derives feature patterns as MFCCs corresponding to individual phonemes that are included in the speech signals input in time series, by concatenating the MFCCs calculated on a frame-by-frame basis, in accordance with a HMM (Hidden Markov Model).

Here, “phoneme” refers to elements of sound that are regarded as being the same in a given language. In the following, the case where Japanese is used as the language will be described. Phonemes in Japanese are the vowels “a”, “i”, “u”, “e” and “o”, consonants such as “k”, “s”, “t” and “n”, the half vowels “j” and “w”, and the special mora “N”, “Q” and “H”.

The speech recognition database storage unit 83 stores a speech recognition database that includes standard patterns representing the distribution state of the frequency component with regard to various types of phonemes that are used in a predetermined language. In the speech recognition database, text data representing various types of phonemes and standard patterns serving as option information are accumulated in association with each other.

The standard patterns are created in advance using the speech of a large number of speakers (e.g., around 200). In creating the standard patterns, MFCCs are derived from the speech signals representing the respective phonemes. In the MFCCs created using the speech of a large number of speakers, there is, however, variation in the respective numerical values.

Accordingly, the standard patterns for the respective phonemes have a spread that includes variation in multi-dimensional space (e.g., 12-dimensional space). If a feature pattern generated from a speech signal input to the signal processor 64 is within a range of the spread of the standard patterns, both phonemes are determined to coincide.

For example, the coincidence detection unit 65 compares the feature pattern generated from the first syllable of the input speech signal with a standard pattern corresponding to the first syllable of the respective words or sentences that are represented by the text data of the plurality of options that are included in the speech recognition option data. In the case where only one option having a first syllable with respect to which coincidence is detected exists among in the plurality of options, the coincidence detection unit 65 may determine that that option is the converted word or sentence. On the other hand, in the case where a plurality of options having a first syllable with respect to which coincidence was detected exist among the plurality of options, the coincidence detection unit 65 may expand the range of syllables with respect to which coincidence is to be detected until the options are narrowed down to one.

Here, a “syllable” refers to a collection of sounds that has one vowel as the main sound and is constituted by that one vowel or with one or more consonants before and/or after that vowel. Half vowels and special mora can also constitute a syllable. That is, one syllable is constituted by one or more phonemes. Japanese syllables include “ [symbol] ” (“a”), “ [symbol] ” (“i”), “ [symbol] ” (“u”), “ [symbol] ” (“e”), “ [symbol] ” (“o”), “ [symbol] ” (“ka”), “ [symbol] ” (“ki”), “ [symbol] ” (“ku”), “ [symbol] ” (“ke”) and “ [symbol] ” (“ko”).

For example, the standard pattern corresponding to the syllable “ [symbol] ” is the standard pattern representing the phoneme “a” that constitutes the syllable “ [symbol] ”. Also, the standard pattern corresponding to the syllable “ [symbol] ” is a combination of the standard pattern representing the first phoneme “k” constituting the syllable “ [symbol] ” and the standard pattern representing the second phoneme “a” constituting the syllable “ [symbol] ”.

In the case where one syllable of the input speech signal is constituted by one phoneme, coincidence of the syllable will be detected if coincidence is detected with respect to that phoneme. On the other hand, in the case where one syllable of the input speech signal is constituted by a plurality of phonemes, coincidence of the syllable will be detected if coincidence of those phonemes is detected.

When coincidence such as described above is detected between a feature pattern and a standard pattern, the coincidence detection unit 65 outputs information specifying words or sentences having syllables with respect to which coincidence was detected among the plurality of words or sentences, such as, for example, text data representing those words or sentences, as a speech recognition result. Thereby, the host CPU 121 is able to recognize words or sentences corresponding to at least a portion of the speech signal input to the semiconductor device 100.

### Speech Recognition Method 1

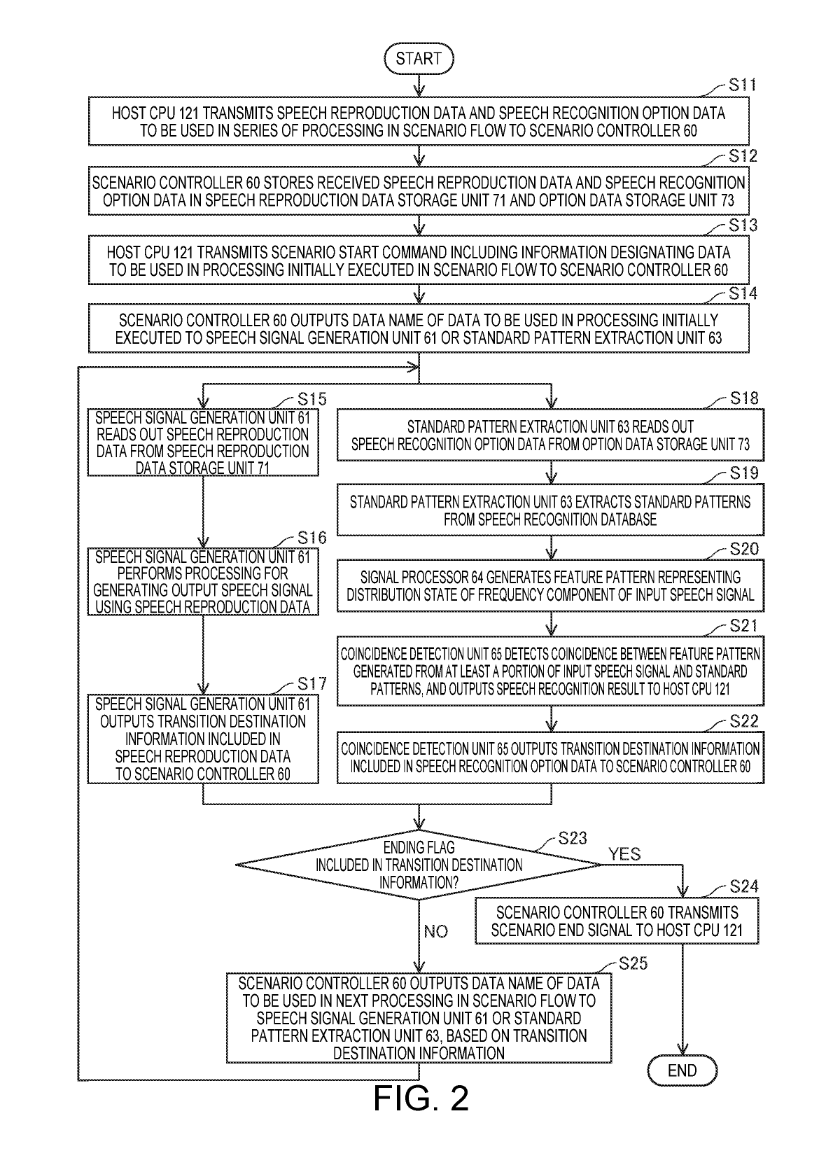

Next, a speech recognition method according to the first embodiment of the invention will be described, referring to FIGS. 1 and 2.

FIG. 2 is a flowchart showing the speech recognition method according to the first embodiment of the invention. In the first embodiment, the case will be described where speech reproduction data and speech recognition option data that are used in the series of processing in the scenario flow are collectively transmitted to the scenario controller 60, and the speech reproduction data and the speech recognition option data each include transition destination information. Note that a configuration may be adopted in which image reproduction data is furthermore used, as was described with reference to FIG. 1.

In step S11 of FIG. 2, the host CPU 121 transmits speech reproduction data and speech recognition option data to be used in the series of processing in the scenario flow to the scenario controller 60 by attachment to a data transfer command.

In step S12, the scenario controller 60 stores the received speech reproduction data and speech recognition option data in the speech reproduction data storage unit 71 and the option data storage unit 73, in accordance with the type of data.

In step S13, the host CPU 121 transmits a scenario start command that includes information specifying data to be used in processing that is initially executed in the scenario flow to the scenario controller 60.

In step S14, the scenario controller 60 outputs the data name of the data to be used in processing that is initially executed to the speech signal generation unit 61 or the standard pattern extraction unit 63, in accordance with the type of data.

In the case where the data name is output to the speech signal generation unit 61, the speech signal generation unit 61, in step S15, reads out speech reproduction data from the speech reproduction data storage unit 71. In step S16, the speech signal generation unit 61 performs processing for generating an output speech signal using the speech reproduction data. Thereby, speech of a question or message is issued from the speech output unit 40. In step S17, the speech signal generation unit 61 outputs the transition destination information that is included in the speech reproduction data to the scenario controller 60.

On the other hand, in the case where the data name is output to the standard pattern extraction unit 63, the standard pattern extraction unit 63, in step S18, reads out speech recognition option data from the option data storage unit 73. In step S19, the standard pattern extraction unit 63 extracts standard patterns corresponding to at least a portion of respective words or sentences constituting the plurality of options that are represented by speech recognition option data from the speech recognition database.

Next, in step S20, the signal processor 64 extracts the frequency component of the input speech signal by performing a Fourier transform or the like on the input speech signal, and generates a feature pattern representing the distribution state of the frequency component. In step S21, the coincidence detection unit 65 detects coincidence between the feature pattern generated from at least a portion of the input speech signal and the standard patterns, and outputs a speech recognition result to the host CPU 121. In step S22, the coincidence detection unit 65 outputs the transition destination information included in the speech recognition option data to the scenario controller 60.

In step S23, the scenario controller 60 determines whether a scenario ending flag is included in the transition destination information. If a scenario ending flag is included in the transition destination information, the processing transitions to step S24. In step S24, the scenario controller 60 transmits a scenario end signal to the host CPU 121. Thereby, the series of processing in the scenario flow is ended.

On the other hand, if a scenario ending flag is not included in the transition destination information, the processing transitions to step S25. In step S25, the scenario controller 60, based on the transition destination information, outputs the data name of data to be used in the next processing in the scenario flow to the speech signal generation unit 61 or the standard pattern extraction unit 63, in accordance with the type of data. Thereafter, the processing returns to step S15 or S18.

### Second Embodiment

Next, a second embodiment of the invention will be described.

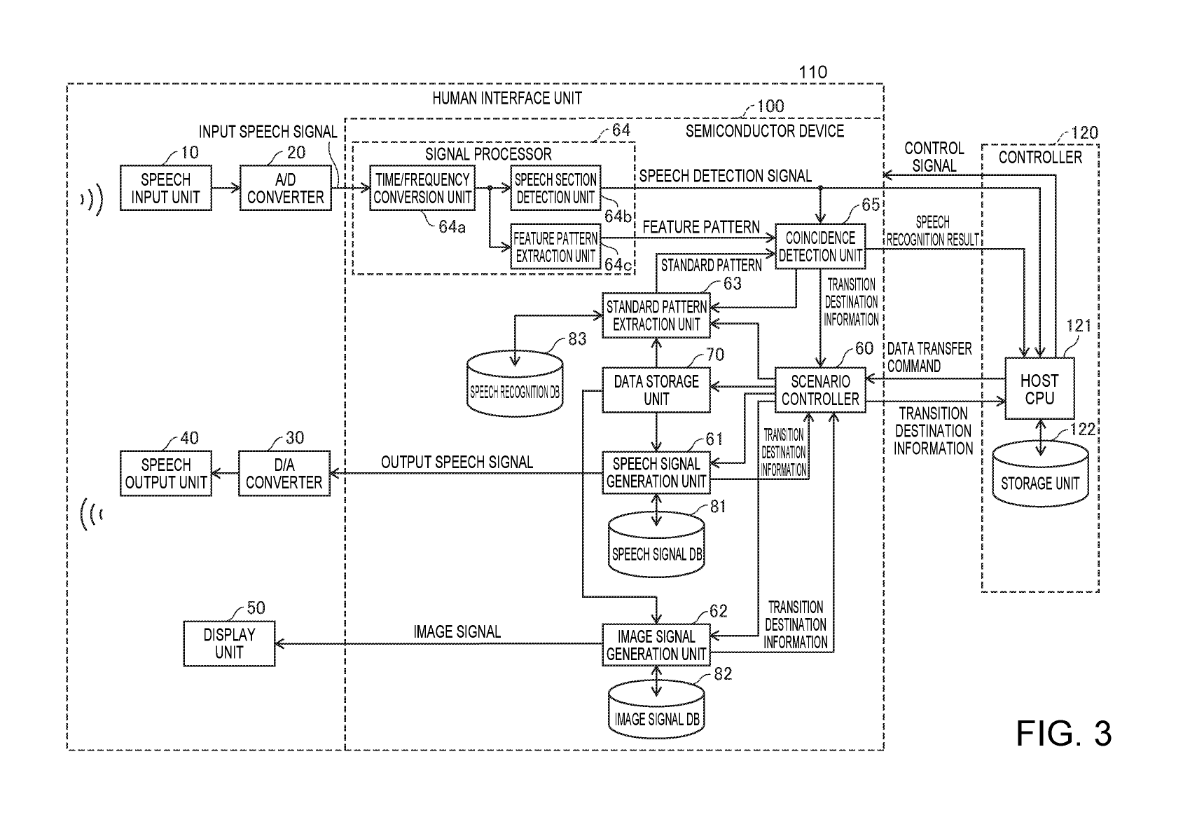

FIG. 3 is a block diagram showing an exemplary configuration of a system using a semiconductor device according to a second embodiment of the invention. In the second embodiment, speech reproduction data, image reproduction data or speech recognition option data to be used in respective processing in the scenario flow is transmitted from the host CPU 121 to the scenario controller 60 each time. Accordingly, a data storage unit 70 is provided instead of the speech reproduction data storage unit 71 to the option data storage unit 73 shown in FIG. 1. With regard to other points, the second embodiment may be configured similarly to the first embodiment.

The scenario controller 60, upon receiving a data transfer command to which speech reproduction data, image reproduction data or speech recognition option data is attached from the host CPU 121, temporarily stores the received data in the data storage unit 70. The data storage unit 70 is constituted by a memory or a resistor, for example. The scenario controller 60 identifies the type of received data and controls the speech signal generation unit 61, the image signal generation unit 62 or the standard pattern extraction unit 63 to read out the received data from the data storage unit 70.

The speech signal generation unit 61, upon reading out speech reproduction data, performs processing for generating an output speech signal representing speech of a question or message for the user, using the speech reproduction data. The image signal generation unit 62, upon reading out image reproduction data, performs processing for displaying an image that includes a question or message for the user on the display unit 50, using the image reproduction data.

The standard pattern extraction unit 63, upon reading out speech recognition option data, extracts standard patterns corresponding to at least some of the individual words or sentences constituting the plurality of options that are represented by the speech recognition option data from the speech recognition database that is stored in the speech recognition database storage unit 83, and the standard pattern extraction unit 63 to the coincidence detection unit 65 perform speech recognition processing on the input speech signal.

Similarly, in this embodiment, the speech signal generation unit 61, the image signal generation unit 62 and the standard pattern extraction unit 63 to the coincidence detection unit 65 perform respective processing using the speech reproduction data, image reproduction data and speech recognition option data read out from the data storage unit 70, and output the transition destination information that is included in the speech reproduction data, image reproduction data and speech recognition option data used in the processing to the scenario controller 60.

The scenario controller 60 transmits that transition destination information to the host CPU 121. Thereby, the host CPU 121, when transition destination information is received from the scenario controller 60, reads out speech recognition option data, speech reproduction data or image reproduction data to be used in the next processing from the storage unit 122, based on the received transition destination information, and transmits the read data to the scenario controller 60 at a predetermined timing by attachment to a data transfer command. Thereby, the scenario controller 60 receives the speech recognition option data, speech reproduction data or image reproduction data to be used in the next processing from the host CPU 121. In that case, the timing of the respective processing in the scenario flow can be externally controlled by the host CPU 121.

In the case where data is not designated in the transition destination information, the series of processing in the scenario flow is ended. Alternatively, a configuration may be adopted in which the transition destination information includes an ending flag (scenario ending flag) representing the end of the series of processing in the scenario flow. In the case where the scenario ending flag is included in the transition destination information, the scenario controller 60 transmits the transition destination information that includes the scenario ending flag to the host CPU 121. Thereby, the end of the series of processing can be notified to the host CPU 121.

### Speech Recognition Method 2

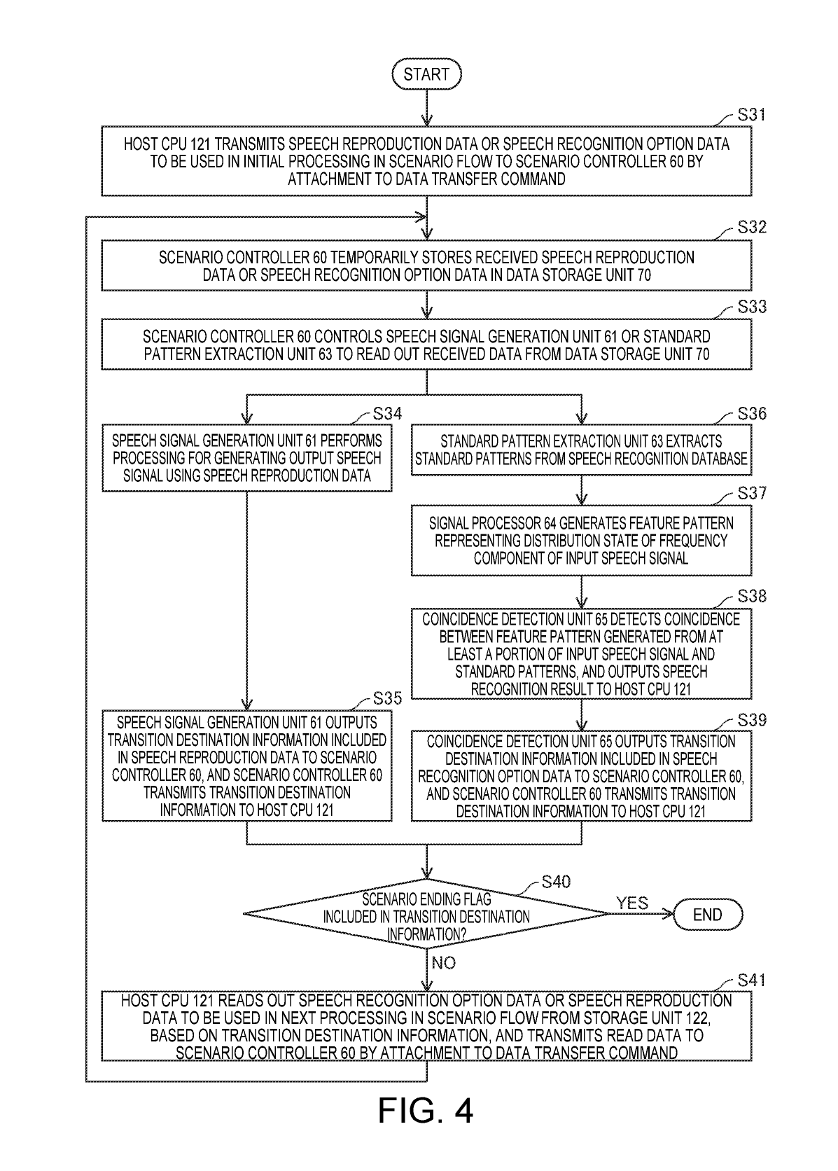

Next, a speech recognition method according to the second embodiment of the invention will be described, with reference to FIGS. 3 and 4.

FIG. 4 is a flowchart showing the speech recognition method according to the second embodiment of the invention. In the second embodiment, the case will be described where speech reproduction data and speech recognition option data that are used in respective processing in the scenario flow are transmitted to the scenario controller 60 each time, and the speech reproduction data and speech recognition option data each include transition destination information. Note that a configuration may be adopted in which image reproduction data is furthermore used, as was described with reference to FIG. 3.

In step S31 of FIG. 4, the host CPU 121 transmits speech reproduction data or speech recognition option data to be used in initial processing in the scenario flow to the scenario controller 60 by attachment to a data transfer command.

In step S32, the scenario controller 60 temporarily stores the received speech reproduction data or speech recognition option data in the data storage unit 70. In step S33, the scenario controller 60 identifies the type of received data and controls the speech signal generation unit 61 or the standard pattern extraction unit 63 to read out the received data from the data storage unit 70.

In the case where the speech signal generation unit 61 reads out speech reproduction data, the speech signal generation unit 61, in step S34, performs processing for generating an output speech signal using the speech reproduction data. Thereby, speech of a question or message is issued from the speech output unit 40. In step S35, the speech signal generation unit 61 outputs the transition destination information that is included in the speech reproduction data to the scenario controller 60, and the scenario controller 60 transmits the transition destination information to the host CPU 121.

On the other hand, in the case where the standard pattern extraction unit 63 reads out speech recognition option data, the standard pattern extraction unit 63, in step S36, extracts standard patterns corresponding to at least some of the individual words or sentences constituting the plurality of options that are represented by the speech recognition option data from the speech recognition database.

Next, in step S37, the signal processor 64 extracts the frequency component of the input speech signal, by performing a Fourier transform or the like on the input speech signal, and generates a feature pattern representing the distribution state of the frequency component. In step S38, the coincidence detection unit 65 detects coincidence between the feature pattern generated from at least a portion of the input speech signal and the standard patterns, and outputs a speech recognition result to the host CPU 121. In step S39, the coincidence detection unit 65 outputs the transition destination information that is included in the speech recognition option data to the scenario controller 60, and the scenario controller 60 transmits the transition destination information to the host CPU 121.

In step S40, the host CPU 121 determines whether a scenario ending flag is included in the transition destination information. In the case where a scenario ending flag is included in the transition destination information, the series of processing in the scenario flow is ended.

On the other hand, in the case where a scenario ending flag is not included in the transition destination information, the processing transitions to step S41. In step S41, the host CPU 121 reads out speech recognition option data or speech reproduction data to be used in the next processing in the scenario flow from the storage unit 122, based on transition destination information, and transmits the read data to the scenario controller 60 by attachment to a data transfer command. Thereafter, the processing returns to step S32.

According to the first or second embodiment of the invention, transition destination information is embedded in speech reproduction data or speech recognition option data, and thus, in the case where the scenario in speech recognition needs to be changed, it is possible to change the scenario, by only changing the speech reproduction data or the speech recognition option data. Accordingly, it becomes possible to provide a system that is able to easily realize setting and changing of the scenario in speech recognition even without setting or changing the scenario flow in a program of the host CPU 121.

### Specific Example of Speech Recognition Method

Next, a specific example of the speech recognition method will be described. In the following, the case where the system shown in FIG. 3 is applied to control of a lighting fixture will be described as an example.

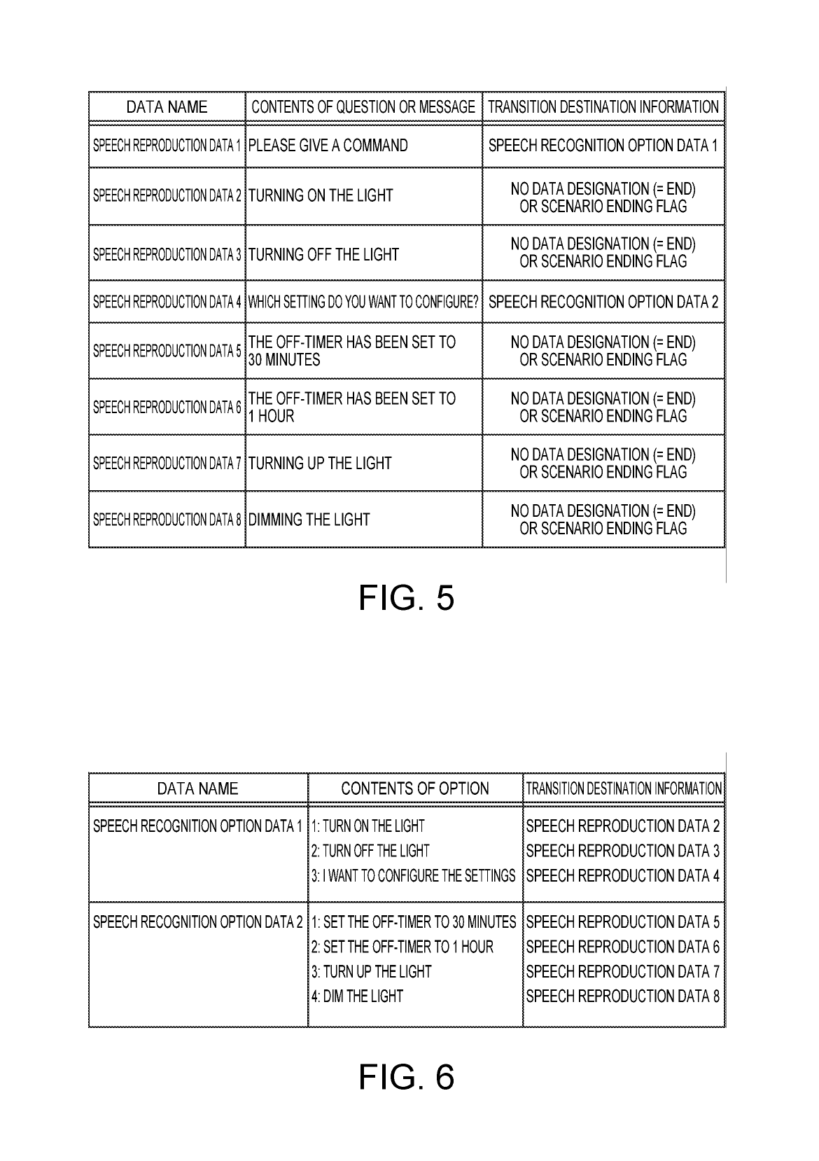

FIG. 5 is a diagram showing exemplary speech reproduction data stored in the storage unit. In this example, speech reproduction data 1 to 8 as data names, text data representing the contents of respective questions or messages, and respective transition destination information are stored in the storage unit 122 in association with each other. The text data includes data representing alphabetical notation or kana notation that is able to specify phonemes that are included in the questions or messages.

FIG. 6 is a diagram showing exemplary speech recognition option data that is stored in the storage unit. In this example, option data 1 and 2 as data names, text data representing the contents of the respective options, and respective transition destination information are stored in the storage unit 122 in association with each other. The text data includes data representing alphabetical notation or kana notation that is able to specify phonemes that are included in the options.

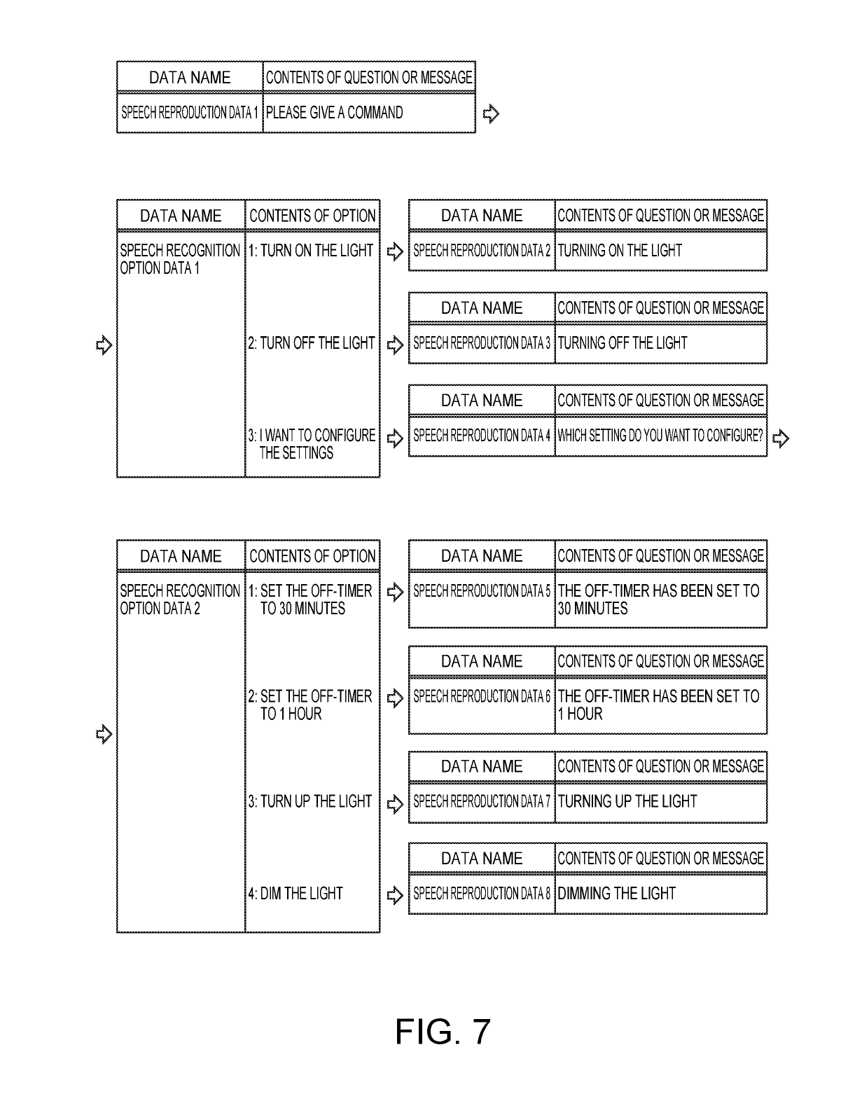

FIG. 7 is a diagram showing an exemplary speech recognition scenario that is constructed by the speech reproduction data shown in FIG. 5 and the speech recognition option data shown in FIG. 6. For example, the host CPU 121 responds to the output signal of a motion sensor or the like, and starts up the human interface unit 110. Furthermore, the host CPU 121 reads out the speech reproduction data shown in FIG. 5 and the speech recognition option data shown in FIG. 6 from the storage unit 122, and sequentially transmits the read data to the scenario controller 60 according to the progress of respective processing in the scenario flow.

When the host CPU 121 transmits speech reproduction data 1 to the scenario controller 60, the speech signal generation unit 61 generates an output speech signal based on the speech reproduction data 1, and outputs the output speech signal to the D/A converter 30. Also, the D/A converter 30 converts the digital speech signal into an analog speech signal, and outputs the analog speech signal to the speech output unit 40. Thereby, the speech output unit 40 issues the message “Please give a command” together with a chime or the like.

As shown in FIG. 5, the speech reproduction data 1 includes transition destination information specifying speech recognition option data 1. Accordingly, upon the scenario controller 60 transmitting the transition destination information to the host CPU 121, the host CPU 121 transmits the speech recognition option data 1 to the scenario controller 60.

As shown in FIG. 6, the speech recognition option data 1 includes a first option “Turn on the light”, a second option “Turn off the light”, and a third option “I want to configure the settings”. In view of this, the standard pattern extraction unit 63 extracts corresponding standard patterns from the speech recognition database 83 with regard to each of the plurality of phonemes that are included in the first to third options of the speech recognition option data 1.

When the user replies with speech to the message “Please give a command” issued from the speech output unit 40, the signal processor 64 generates a feature pattern representing the distribution state of frequency components with regard to each of the plurality of phonemes that are included in the reply of the user. The coincidence detection unit 65 detects coincidence between the reply of the user and the first to third options of the speech recognition option data 1, by comparing the feature patterns of the phonemes generated by the signal processor 64 with the standard patterns of the phonemes extracted from the speech recognition database.

As shown in FIG. 6, the speech recognition option data 1 respectively includes transition destination information specifying speech reproduction data 2 to 4, in correspondence with the first to third options. Accordingly, in the case where the user replies “Turn on the light”, the scenario controller 60 transmits transition destination information specifying the speech reproduction data 2 to the host CPU 121, and the host CPU 121 transmits the speech reproduction data 2 to the scenario controller 60. Thereby, the speech output unit 40 issues the message “Turning on the light”.

Similarly, in the case where the user replies “Turn off the light”, the speech output unit 40 issues the message “Turning off the light”. The host CPU 121 receives the speech recognition result that is transmitted from the coincidence detection unit 65, and performs control for turning the power switch of the lighting fixture on or off. On the other hand, if the user replies “I want to configure the settings”, the speech output unit 40 issues the question “Which setting do you want to configure?”.

As shown in FIG. 5, the speech reproduction data 4 includes transition destination information specifying speech recognition option data 2. Accordingly, when the scenario controller 60 transmits that transition destination information to the host CPU 121, the host CPU 121 transmits the speech recognition option data 2 to the scenario controller 60.

The speech recognition option data 2 includes a first option “Set the off-timer to 30 minutes”, a second option “Set the off-timer to 1 hour”, a third option “Turn up the light”, and a fourth option “Dim the light”. In view of this, the standard pattern extraction unit 63 extracts corresponding standard patterns from the speech recognition database with regard to each of the plurality of phonemes that are included in the first to fourth options of the speech recognition option data 2.

When the user replies with speech to the question “Which setting do you want to configure?” emitted from the speech output unit 40, the signal processor 64 generates a feature pattern representing the distribution state of frequency components with regard to each of the plurality of phonemes included in the reply of the user. The coincidence detection unit 65 detects coincidence between the reply of the user and the first to fourth options of the speech recognition option data 2, by comparing the feature patterns of the phonemes generated by the signal processor 64 with the standard patterns of the phonemes extracted from the speech recognition database.

As shown in FIG. 6, the speech recognition option data 2 respectively includes speech reproduction data 5 to 8 as transition destination information corresponding to the first to fourth options. Accordingly, in the case where the user replies “Set the off-timer to 30 minutes”, the scenario controller 60 transmits transition destination information specifying the speech reproduction data 5 to the host CPU 121, and the host CPU 121 transmits the speech reproduction data 5 to the scenario controller 60, after setting the off-timer to 30 minutes.

Thereby, the speech output unit 40 issues the message “The off-timer has been set to 30 minutes”. Similarly, in the case where the user replies “Set the off-timer to 1 hour”, the speech output unit 40 issues the message “The off-timer has been set to 1 hour” after the host CPU 121 has set the off-timer to 1 hour.

Also, in the case where the user replies “Turn up the light”, the speech output unit 40 issues the message “Turning up the light”. Similarly, in the case where the user replies “Dim the light”, the speech output unit 40 issues the message “Dimming the light”. The host CPU 121 adjusts the lighting fixture in accordance with the speech recognition result that is transmitted from the coincidence detection unit 65.

### Electronic Device

Next, an electronic device according to one embodiment of the invention will be described.

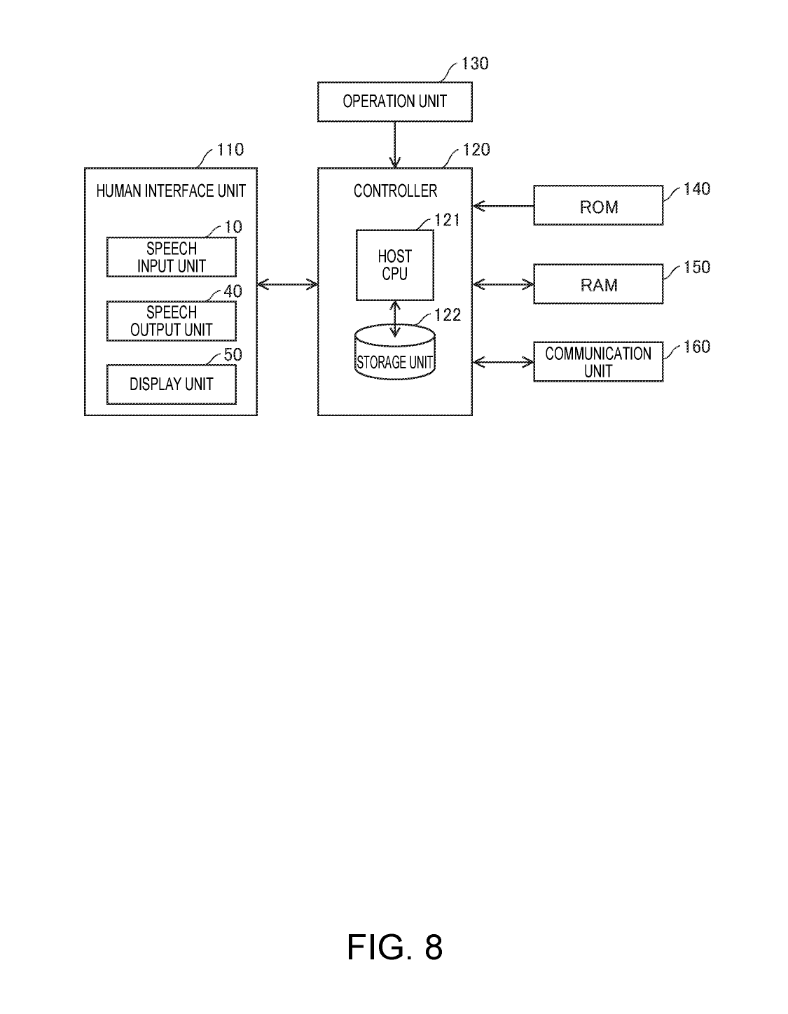

FIG. 8 is a block diagram showing an exemplary configuration of the electronic device according to one embodiment of the invention. This electronic device uses the system shown in FIG. 1 or 3. As shown in FIG. 8, this electronic device includes the human interface unit 110, the controller 120, an operation unit 130, a ROM (read-only memory) 140, a RAM (random access memory) 150, and a communication unit 160. Note that some of the constituent elements shown in FIG. 8 may be omitted or changed, or other constituent elements may be added to the constituent elements shown in FIG. 8.

The human interface unit 110, under the control of the controller 120, issues a question or message conveyed through speech or an image to the user, and also recognizes the speech of the user who replies to the question or message, and transmits the speech recognition result to the controller 120. The controller 120 includes the host CPU 121 and the storage unit 122. The host CPU 121 performs various types of control processing and signal processing based on the speech recognition result that is transmitted from the human interface unit 110, in accordance with a program that is stored in the storage unit 122 or the like.

For example, the host CPU 121 adjusts the brightness of lighting, the set temperature of an air-conditioner or a microwave oven, the volume of a television, and the like, and has conversations with the user, based on the speech recognition result transmitted from the human interface unit 110. At that time, the host CPU 121 controls the communication unit 160 in order to perform processing such as generating speech reproduction data for causing the speech output unit 40 to output various types of speech, generating image reproduction data for displaying various types of images on the display unit 50, and performing data communication with the outside.

The operation unit 130 is, for example, an input device that includes operation keys, button switches and the like, and outputs operation signals that depend on operations by the user to the host CPU 121. The ROM 140 stores data for the host CPU 121 to perform various types of signal processing and control processing, and the like. Also, the RAM 150 is used as a workspace of the host CPU 121, and temporarily stores data input using the operation unit 130, data read out from the ROM 140, or the results of computational operations executed by the host CPU 121 in accordance with a program. The communication unit 160 is constituted by an analog circuit and a digital circuit, and performs data communication between the controller 120 and an external device, for example.

Electronic devices include, for example, home electronics or home installations such as lighting fixtures, air conditioners, and microwave ovens, cleaning and carer robots, vending machines, in-vehicle devices (navigation devices, etc.), mobile terminals such as mobile phones, smart cards, calculators, electronic dictionaries, electronic game machines, digital still cameras, digital video cameras, televisions, TV phones, surveillance television monitors, head-mounted displays, personal computers, printers, measurement devices, medical equipment, and the like.

According to this embodiment, it becomes possible to provide an electronic device that is able to easily realize setting and changing of a scenario in speech recognition even without setting or changing the scenario flow in a program of the host CPU 121. The invention is not limited to the foregoing embodiments, and numerous variations can be made within the technical concept of the invention by a person with ordinary skill in the applicable technical field.

This application claims priority from Japanese Patent Application No. 2015-186472 filed in the Japanese Patent Office on Sep. 24, 2015 the entire disclosure of which is hereby incorporated by reference in its entirely.

What is claimed is:

1. A semiconductor device comprising:
a data storage unit configured to store speech reproduction data that includes transition destination information or speech recognition option data that includes transition destination information; and
a processor configured to perform processing for generating an output speech signal using speech reproduction data read out from the data storage unit or perform speech recognition processing on an input speech signal using speech recognition option data read out from the data storage unit, and to read out, based on the transition destination information included in speech reproduction data or speech recognition option data used in the processing, speech recognition option data or speech reproduction data to be used in the next processing from the data storage unit.

2. The semiconductor device according to claim 1, wherein
the data storage unit is configured to further store image reproduction data that includes transition destination information, and
the processor is configured to perform processing for generating an output speech signal using speech reproduction data read out from the data storage unit, processing for displaying an image that includes a question or message using image reproduction data read out from the data storage unit or speech recognition processing on an input speech signal using speech recognition option data read out from the data storage unit, and to read out, based on the transition destination information included in speech reproduction data, image reproduction data or speech recognition option data used in the processing, speech recognition option data, speech reproduction data or image reproduction data to be used in the next processing from the data storage unit.

3. The semiconductor device according to claim 1, wherein the processor includes a scenario controller configured to transmit, to outside, the transition destination information included in speech reproduction data, image reproduction data or speech recognition option data used in the processing, and to receive, from outside, speech recognition option data, speech reproduction data or image reproduction data to be used in the next processing.

4. The semiconductor device according to claim 1, wherein the transition destination information includes an ending flag representing an end of a series of processing.

5. A system comprising:
the semiconductor device according to claim 1; and
a controller configured to control the semiconductor device.

6. The system according to claim 5, wherein
the controller includes:
a storage unit configured to store speech reproduction data that includes transition destination information, image reproduction data that includes transition destination information, or speech recognition option data that includes transition destination information; and
a host CPU configured to, when transition destination information is received from the semiconductor device, read out speech recognition option data, speech reproduction data or image reproduction data to be used in the next processing from the storage unit, based on the received transition destination information, and transmit the read data to the semiconductor device.

7. An electronic device comprising the system according to claim 5.

8. An electronic device comprising the system according to claim 6.

9. A speech recognition method comprising:
(a) reading out first speech reproduction data or first speech recognition option data from a data storage unit configured to store speech reproduction data that includes transition destination information or speech recognition option data that includes transition destination information;
(b) performing processing for generating an output speech signal using the first speech reproduction data or performing speech recognition processing on an input speech signal using the first speech recognition option data;
(c) reading out, based on the transition destination information included in first speech reproduction data or first speech recognition option data used in the processing in (b), second speech recognition option data or second speech reproduction data to be used in the next processing from the data storage unit; and
(d) performing speech recognition processing on an input speech signal using the second speech recognition option data or generating an output speech signal using the second speech reproduction data.
